(19) United States
(12) Patent Application Publication
(10) Pub. No.: US 2015/0095378 A1
(43) Pub. Date: Apr. 2, 2015

(54) METHOD FOR AUTOMATED DOCUMENTATION OF STRUCTURED QUERY LANGUAGE INCLUDING WORKFLOW AND DATA DEPENDENCIES

(71) Applicant: Genesisone, Inc., Reston, VA (US)

(72) Inventor: Mark Pomponio, Locust Grove, VA (US)

(21) Appl. No.: 14/394,995

(22) PCT Filed: Apr. 16, 2013
(86) PCT No.: PCT/US2013/036846

§ 371 Date: Oct. 16, 2014

Related U.S. Application Data
(60) Provisional application No. 61/624,769, filed on Apr. 16, 2012.

(51) Int. Cl. G06F 17/30; G06F 17/27

(52) U.S. Cl. CPC G06F 17/30289; G06F 17/30917; G06F 17/2705; G06F 17/30498
USPC 707/802

(57) ABSTRACT

An improved documentation tool for software database systems is provided that self- documents and stores code segments in uncompiled form to increase efficiency of code development and operation. Embodiments of the documentation tool provide a methodology for obtaining all detailed information about SQL code including workflow, and all detailed dependencies. The inventive methodology will work with all current database platforms, and is intended to be primarily rules-driven, although the latter is not necessary. Embodiments of the methodology leverage readily identifiable keywords within SQL to make it possible to establish a rules-based process which can then be applied to all other database platforms and coding languages.

### CROSS-REFERENCE TO RELATED APPLICATION

This application claims priority of U.S. Provisional Patent Application Ser. No. 61/624,769 filed Apr. 16, 2012, which is incorporated herein by reference.

### FIELD OF THE INVENTION

The present invention in general relates to database systems, and more particularly, to a software database system that self-documents and stores code segments in uncompiled form to increase efficiency of code development and operation.

### BACKGROUND OF THE INVENTION

Current industry documentation of structured query language (SQL) is limited to showing object dependencies and displaying metadata that is available with most all database programs.

Currently there are no methods available for documenting data flow within database servers. Nearly all available documentation methods simply query the database metadata, which is readily available on all commercial database platforms. Most platforms utilize an “information schema” schema to collect this metadata, similar to the way object-oriented languages rely heavily on reflection to obtain this same sort of metadata. While this provides an overview of the structure and some limited information on object relationships, it does very little to provide insight into the code that runs the applications. FIG. 1 shows the dependency information available in SQL Server Version 2008, Release 2. The FIG. 1 screenshot of a user interface (UI) shows the limited information available for digging deeper into the code to determine more detailed dependencies. An example of greater detail would be to display which columns are being used by the views shown in the graphic. Since a view can use a subset of columns in a table, it is not possible to determine if a column in that table is actually being used. The information provided with current technology shows only the higher-level table dependencies.

Furthermore, presently available documentation tools provide very limited information, and the tools are limited to either the database or application, but not both. On the database side, the documentation is simply a report on “metadata” which is available in most every database and provides information on the database structure, not on the details of the code. On the application side, the type of documentation is primarily limited to “classes” (higher abstraction levels within an application), and how these classes relate to each other (called “reflection”). There are also tools which read “code comments”, but these tools are only useful if the code comments were created by the developer who wrote the code, and in most applications, developers don't do this. There are a limited number of other tools that do follow the logical branches within an application, but these do not follow the data nor do they extend into the database code, therefore providing, at best, half the required information.

Thus, there exists a need for an improved documentation tool for software database system that self-documents and stores code segments in uncompiled form to increase efficiency of code development and operation.

### SUMMARY OF THE INVENTION

An improved documentation tool for software database systems is provided that self-documents and stores code segments in uncompiled form to increase efficiency of code development and operation. Embodiments of the documentation tool provide a methodology for obtaining all detailed information about SQL code including workflow, and all detailed dependencies. The inventive methodology will work with all current database platforms, and is intended to be primarily rules-driven, although the latter is not necessary. Embodiments of the methodology leverage readily identifiable keywords within SQL to make it possible to establish a rules-based process which can then be applied to all other database platforms and coding languages.

Embodiments of the present invention document all elements of code down to the most detailed level, showing all logical relationships and how the code and data flow through an application, both on the database level and application level. Embodiments of the invention solve the problem with current technology where there is no documentation tool that exists which shows how everything flows through a system, nor is there a program which provides detailed information about both key components of a system and how they work together, as embodiments of the documentation tool does. While this type of documentation is difficult to generate, primarily because of the variations of coding that are allowed on the database side, embodiments of the present invention accurately document the code regardless of the method used to write the database code.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a screenshot of the dependency information available in the SQL Server Version 2008, Release 2 user interface;

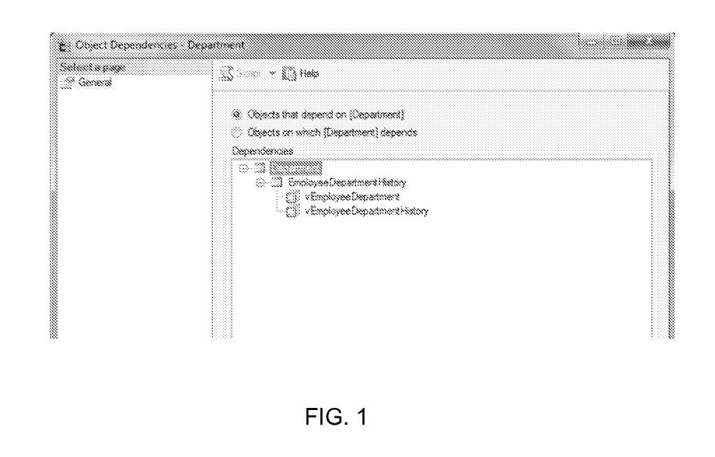

FIG. 2 is a flowchart of the inventive method according to an embodiment of the invention;

FIG. 3 shows how a list of keywords and their positions may be used to discern all other elements of the code according to embodiments of the invention; and

FIG. 4 is a schematic diagram illustrating an overall view of communication devices, computing devices, and mediums for implementing a documentation and analysis tool according to embodiments of the invention.

### DESCRIPTION OF THE INVENTION

An improved documentation tool for software database systems is provided that self-documents and stores code segments in uncompiled form to increase efficiency of code development and operation. Embodiments of the documentation tool provide a methodology for obtaining all detailed information about SQL code including workflow, and all detailed dependencies. The inventive methodology will work with all current database platforms, and is intended to be primarily rules-driven, although the latter is not necessary. Embodiments of the methodology leverage readily identifiable keywords within SQL to make it possible to establish a rules-based process which can then be applied to all other database platforms and coding languages.

Embodiments of the present invention document all elements of code down to the most detailed level, showing all logical relationships and how the code and data flow through an application, both on the database level and application level. Embodiments of the invention solve the problem with current technology where there is no documentation tool that exists which shows how everything flows through a system, nor is there a program which provides detailed information about both key components of a system and how they work together, as embodiments of the documentation tool does. While this type of documentation is difficult to generate, primarily because of the variations of coding that are allowed on the database side, embodiments of the present invention accurately document the code regardless of the method used to write the database code.

Embodiments of the inventive approach for documenting database operations are able to document data flow throughout an entire application, while providing the same level of documentation on both the application side and the database side, thereby providing needed information for programmers to both build a system and to maintain a system. The features of the inventive software documentation tool are important since software code is very complex and the larger the system, the greater the complexity of the software code, and when a code change is made, the effect can ripple through a system in ways that no one could have expected. Presently, the effect of code changes is analyzed manually and is prone to error.

Embodiments of the invention are applicable for use in system conversions by providing a user with the ability to “look into” an existing code base and see exactly what's happening, and is vital to planning and developing a new system or system conversion. Embodiments of the invention may also be used in system maintenance, where during the lifecycle of any application, issues arise because of unexpected data inputs that create unanticipated functionality problems. Embodiments of the inventive software tool help software developers quickly and accurately isolate and resolve the unanticipated functionality problems. Furthermore, the inventive software tool may be used for system enhancements. For example, invariably, all systems are constructed with business assumptions which change based on the changes in the organizational environment in which a business or agency operates. With embodiments of the present invention, it is possible for the first time to accurately and visually see how any enhancement will affect the current functionality of the software application and system.

The accurate information provided by embodiments of the invention to users who develop, maintain, or augment software systems save them time and money and will help to mitigate potential overruns in development budgets and timelines. Embodiments of the present invention will save considerable time, and consequently substantial amounts of money, in all phases of development, maintenance and system modification. The impact will be much lower costs, a considerably reduced number of software problems, and significantly more rapid turnaround on any development effort. This effect can be initially measured by turnaround time and reduced number of software issues, and will consequently be seen in reduced overall cost. Also helped by the reduced time and reduced level of software issues are project managers, those concerned with budgets, and users of the system.

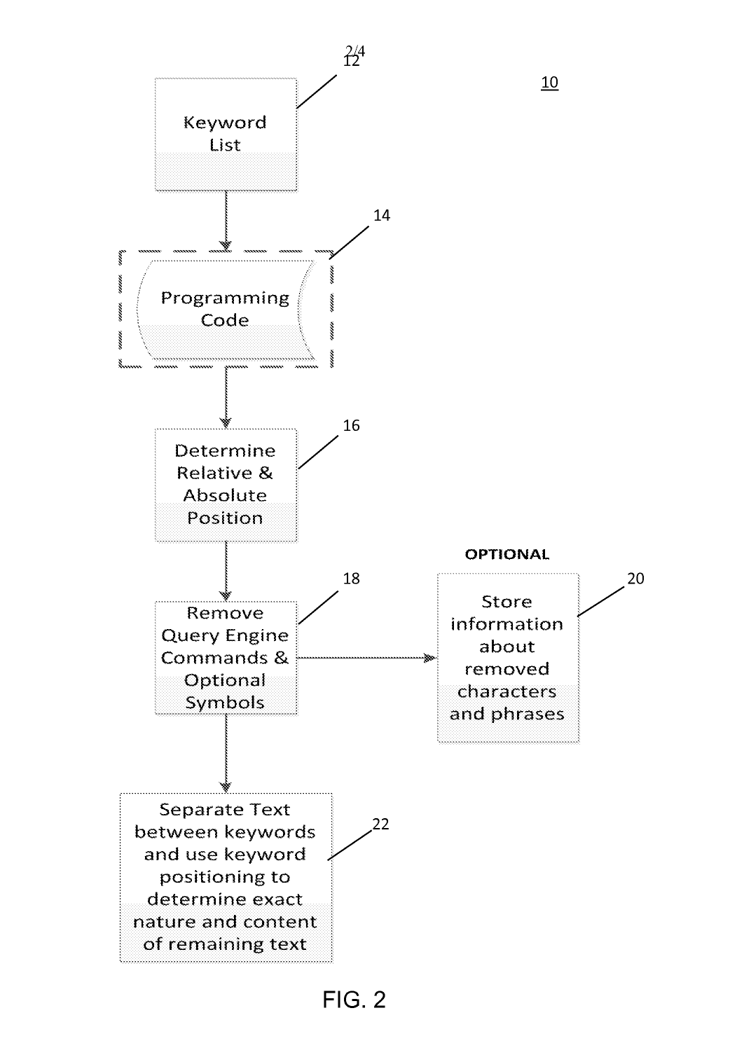

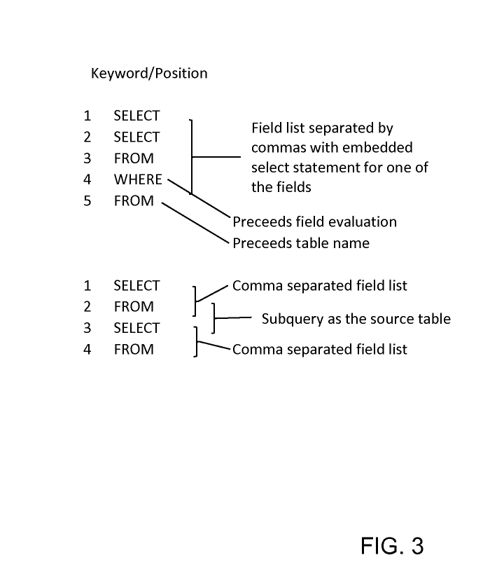

FIG. 3 illustrates a flowchart of a process 10 for implementing embodiments of the invention. The process begins at step 12 with accessing a complete list of keywords. These keywords may be obtained by storing the complete list in a structure that enables direct query or by other means, whether part of current technology or in a manner yet to be invented. In searching the code text (step 14) for each of the keywords, the relative and absolute position of the keyword within the code text would then be noted, parsed, and stored in a manner enabling later retrieval at step 16. In the process of identifying keywords and their position, this information can then be used to develop discrete logical rules which can be applied to determine all of the data flow and object mapping of any SQL code at step 20. These rules can also be stored and used as needed, enabling different rules for different SQL and coding languages. The example in FIG. 2 shows how a list of keywords and their positions can be used to very easily (and programmatically) discern all other elements of the code. As part of the parsing, it is also possible to identify keywords and key phrases and optionally replace them with alternate characters, spaces, or simply removal at step 18. This would provide the benefit of removing code that controls database engine directions (e.g., which indexes to use) from code control flow.

For further information gathering, these “optional” symbols or key phrases can also be stored (step 20) along with their relative and absolute position, though it is not necessary for the invention. In step 22 text is separated between keyword, and keyword positioning is used to determine the exact nature and content of remaining text.

In embodiments, the first step in parsing SQL code is to remove any keywords or command phrases which do not relate to data movement (step 18). The primary type of code which falls into this category is code that is meant to direct database engine execution (e.g., “Begin Transaction”, “Set Nocount On”, etc.). Because this type of code is common to most database platforms it is possible to store the finite set of commands in a database table or other referential structure and cycle through them to remove all such commands from the code prior to continuing to the next steps. Although storage would provide more consistency in execution, it is not mandatory, and can be achieved by other means using current technology or technology yet to be invented.

Since SQL is intended to provide flexibility in writing code, there are numerous ways to write the code to achieve the same desired result. Because of this, it is necessary to either identify each approach prior to moving to the next step, or to pare down the possibilities to one. Either approach can be used, but it is the latter approach that will be expanded upon herein. In paring down possibilities to a single option, it is recommended to maintain a list of such code and its corresponding replacement. One such example is in table joins. To achieve a table join, a developer can use JOIN, INNER JOIN, OUTER JOIN, LEFT OUTER JOIN, LEFT JOIN, RIGHT JOIN, RIGHT OUTER JOIN and CROSS JOIN. Although several produce different results, they all precede a table object, and make it more accurate in identifying workflow. To pare down the possibilities to one, a recursive search and replace would need to be performed for each of the key phrases above. A way to achieve this is to begin with the key phrase with the greatest character length, and cycle to the one with the shortest character length. This will ensure that OUTER JOIN does not get replaced prior to RIGHT OUTER JOIN is replaced. All such possibilities should be identified prior to execution and stored, although that is not required. This same method also applies for commas or other symbols without surrounding spaces, duplicate spaces, code comments and any other pattern that could present itself in multiple forms without affecting results.

In embodiments, the variation of line-feed versus continuous string is also addressed to provide the greatest precision. With SQL, it is possible to include any amount of blank space without affecting the execution of the code, and this can be within a line or throughout a code page. In removing the blank space, it would then become possible to concatenate all of the lines into a continuous string, thereby reducing the possible code page formats to a single possibility. With the reduction of code options to a single possibility, any method can then be used to parse the core code, several of which exist today.

Since the inventive process is meant to document and provide information about any given database or servers, it is recommended to store the information obtained in the above steps in a database, preferable one with a referential structure so that information can be easily retrieved for use as needed. Although this is recommended, it is not required. Alternate methods may be used such as creation of the workflow, or other report as the steps are being executed or other means currently available or not yet invented.

In embodiments, it is possible to store information about the code which is either replaced or removed to provide additional information about the code to the user, but this is not required for the process to work correctly. This process may be performed using any coding language, or any combination thereof, to execute the tasks outlined in embodiments of the inventive method.

The present invention is further detailed with respect to usage in the context of mapping data to a new database as detailed in U.S. Patent Publication 2010/0070954 entitled, “Custom Database System and Method of Building and Operating the Same” herein incorporated by reference in its entirety.

Commercial software packages and patent references mentioned herein are indicative of the level of skill in the art to which the invention pertains. These software packages are hereby incorporated by reference to the extent as if each individual package was individually and explicitly incorporated by reference.

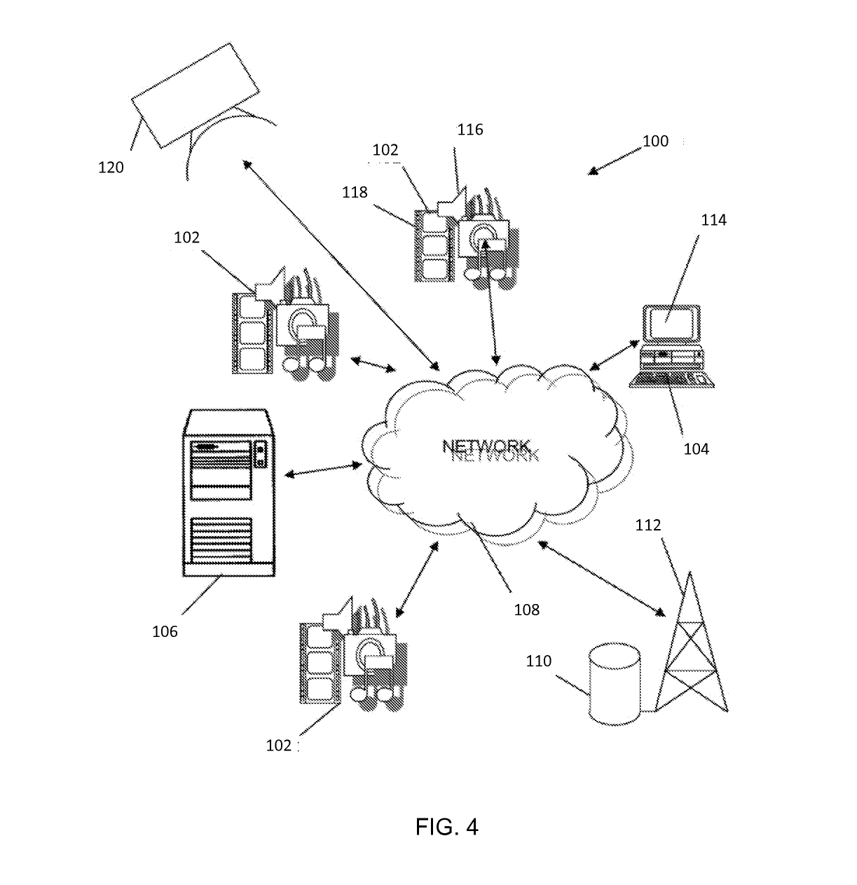

FIG. 4 is a schematic diagram illustrating an overall view of communication devices, computing devices, and mediums for implementing a documentation and analysis tool according to embodiments of the invention.

The system 100 includes multimedia devices 102 and desktop computer devices 104 configured with display capabilities 114. The multimedia devices 102 are optionally mobile communication and entertainment devices, such as cellular phones and mobile computing devices that are wirelessly connected to a network 108. The multimedia devices 102 have video displays 118 and audio outputs 116. The multimedia devices 102 and desktop computer devices 104 are optionally configured with internal storage, computing processors, software, and a graphical user interface (GUI) for carrying out elements of the documentation and analysis tool according to embodiments of the invention. The network 108 is optionally any type of known network including a fixed wire line network, cable and fiber optics, over the air broadcasts, satellite 120, local area network (LAN), wide area network (WAN), global network (e.g., Internet), intranet, etc. with data/Internet capabilities as represented by server 1406. Communication aspects of the network are represented by cellular base station 110 and antenna 112. In a preferred embodiment, the network 108 is a LAN and each remote device 102 and desktop device 104 executes a user interface application (e.g., Web browser) to contact the server system 106 through the network 108. Alternatively, the remote devices 102 and 104 may be implemented using a device programmed primarily for accessing network 108 such as a remote client.

The software for the documentation and analysis tool, of embodiments of the invention, may be resident on the individual multimedia devices 102 and desktop computers 104, or stored within the server 106 or cellular base station 110. Embodiments of the inventive software may be sold or licensed to companies or agencies for running database analysis. In embodiments, the server 106 may implement a cloud-based service for implementing on-demand embodiments of the documentation and analysis tool with a multi-tenant database for storage of separate client data. In on-demand systems, the inventive software is offered as a service to users, companies and agencies who conduct their SQL analysis and documentation without owning the software or hardware on which the analysis is run, but have separate and secure access to their data analysis.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A method for automated documentation of structured query language (SQL) comprising:
removing keywords, symbols or command phrases not relating to data movement in a database and noting their positions for alternate use;
mapping existing rules to the result set or applying rules individually;
parsing the core code; and
generating the automated documentation.

2. The method of claim 1 further comprising noting the relative and absolute position of the keywords, and parsing, and storing the keywords for later retrieval.

3. The method of claim 2 wherein information gained from noting the relative and absolute position of the keywords is used to develop discrete logical rules which can be applied to determine all of the data flow and object mapping of any SQL code.

4. The method of claim 3 wherein said discrete logical rules are stored, enabling different rules to be used for different SQL and coding languages.

5. The method of claim 1 wherein as part of the parsing, identified keywords and key phrases are replaced with alternate characters, spaces, or simply removed.

6. The method of claim 5 wherein the removed keywords and key phrase are stored along with their relative and absolute position.

7. The method of claim 1 further comprising using one or more sets of text that are separated between keywords, and keyword positioning to determine the exact nature and content of any remaining text.

8. The method of claim 1 wherein during achieving a table join in the database a recursive search and replace is conducted to pare down the possibilities for writing the table join to one is performed for each of one or more key phrases used in the table join, by starting with a key phrase with the greatest character length, and cycling to the a key phase with the shortest character length.

9. The method of claim 1 further comprising removing blank spaces in the SQL code and concatenating all of the lines into a continuous string, thereby reducing the possible code page formats to a single possibility.

10. The method of claim 1 wherein said process can be performed using any coding language, or any combination thereof

11. A machine-readable medium storing thereon one or more instructions, which when implemented cause a processor to implement a method for providing automated documentation of structured query language (SQL) the method comprising:
removing keywords, symbols or command phrases not relating to data movement in a database;
mapping existing rules to the result set or applying rules individually;
parsing the core code; and
generating the automated documentation.

13. A system for providing automated documentation of structured query language (SQL), the system comprising:
a server connected via a network to one or more end user devices;
a memory system in electrical communication with said server containing a machine readable medium having stored thereon one or more sequences of instructions which, when executed, cause a method to be carried out, the method comprising;
removing keywords, symbols or command phrases not relating to data movement in a database;
mapping existing rules to the result set or applying rules individually;
parsing the core code; and
generating the automated documentation.
